(19) United States
(12) Patent Application Publication
(10) Pub. No.: US 2003/0082941 A1
(43) Pub. Date: May 1, 2003

(54) Coupling assembly systems and related methods

(76) Inventors: Rachel Kuller, Vancouver, WA (US); John Cantrell, Vancouver, WA (US); Haseeb Yusef, Vancouver, WA (US)

Correspondence Address: HEWLETT-PACKARD COMPANY, Intellectual Property Administration, P.O. Box 272400, Fort Collins, CO, 80527-2400, US

(21) Appl. No.: 10/015,723

(22) Filed: Oct. 30, 2001

(51) Int. Cl. H01R 13/62

(52) U.S. Cl. 439/160

(57) ABSTRACT

Methods and systems for a coupling assembly. In one exemplary embodiment, an assembly can comprise a signal carrying component capable of being coupled with a corresponding receptacle. The assembly can further comprise a steerable component that has at least a portion of which is secured with the signal carrying component. A non-secured portion of the steerable component can be manipulated by a user from a first disposition generally adjacent a portion of the signal carrying component to a second non-adjacent disposition for steering the assembly into the receptacle.

### BACKGROUND

Electrical devices have become ubiquitous in modem society. Generally, these devices are connected to other devices and/or have connections between their internal components. It is often difficult for a user of an electronic device to insert certain cables into their respective connectors. Likewise, it can be very difficult to connect components in desired configurations during manufacture and/or assembly. This can cause increased labor and assembly costs or necessitate re-engineering of the components and their relative orientations. This problem is especially common with flat flexible cables and flexible printed circuits, which can be difficult to grasp and insert into connectors located in very space constrained locations on the electronic device.

The space constraints can make it nearly impossible for a user to make good positive connections, especially given the small size of the connectors and the fact that the connectors are commonly located on the back of the electronic device in areas that are difficult to see or access. Given these environments, a cable that is only partially inserted may cause a user to infer that the electronic device is malfunctioning. This can cause the user to unnecessarily spend time and money on a repair person. This needless down-time can cause diminished productivity and diminished customer satisfaction in the product. Alternatively, if an assembly person does not get proper insertion of a cable connecting components during assembly of a device, it can cause the device to be defective, thus increasing costs and decreasing productivity. Further, attempting to manipulate such small connectors in constrained areas can cause a user and/or assembly person to experience ergonomic distress, and associated discomfort.

Accordingly, this invention arose out of concerns associated with providing an improved coupling assembly(s).

### SUMMARY

The embodiments described below relate to coupling assembly systems and related methods. In one exemplary embodiment, an assembly can comprise a signal carrying component capable of being coupled with a corresponding receptacle. The assembly can further comprise a steerable component that has at least a portion of which is secured with the signal carrying component. A non-secured portion of the steerable component can be manipulated by a user from a first disposition generally adjacent a portion of the signal carrying component to a second non-adjacent disposition for steering the assembly into the receptacle.

In another embodiment, a method of forming coupling assemblies provides one or more signal carrying components and secures less than the entirety of a steerable stiffener with the signal carrying component(s) in a manner that allows a non-secured portion of the steerable stiffener to be manipulated by a user from a first disposition to a second disposition. The first disposition can be adjacent to the signal carrying component(s) and the second disposition can be non-adjacent the signal carrying component(s). The manipulation can allow the signal carrying component(s) to be positioned by the user.

### BRIEF DESCRIPTION OF THE DRAWINGS

The same numbers are used throughout the drawings to reference like features and components.

FIG. 1 is a side plan view of an exemplary printing device in accordance with one embodiment.

FIG. 2 is a block diagram of an exemplary printing device in accordance with one embodiment.

FIG. 3 is a block diagram of an exemplary computing device in accordance with one embodiment.

FIG. 4 is an isometric view of an exemplary coupling assembly in accordance with one embodiment.

FIG. 5 is a cross-sectional view of an exemplary coupling assembly in accordance with one embodiment.

FIG. 6a is an isometric view of an exemplary coupling assembly in accordance with one embodiment.

FIG. 6b is an isometric view of an exemplary coupling assembly in accordance with one embodiment.

FIG. 6c is an isometric view of a corresponding receptacle in accordance with one embodiment.

FIG. 6d is an isometric view of an exemplary coupling assembly in accordance with one embodiment.

FIG. 7a is an isometric view of a coupling assembly in accordance with one embodiment.

FIG. 7b is an isometric view of a corresponding receptacle in accordance with one embodiment.

FIG. 7c is an isometric view of a coupling assembly in accordance with one embodiment.

FIG. 8a is an isometric view of a coupling assembly in accordance with one embodiment.

FIG. 8b is a cross-sectional view of an exemplary coupling assembly in accordance with one embodiment.

FIG. 9 is an isometric view of a coupling assembly in accordance with one embodiment.

FIG. 10 is a flow diagram illustrating steps in a method in accordance with one exemplary embodiment.

FIG. 11 is a flow diagram illustrating steps in a method in accordance with one exemplary embodiment.

### DETAILED DESCRIPTION

Overview

The embodiments described below relate to coupling assemblies (hereinafter, “assembly(s)”) for coupling electronic components within an electronic device and/or for coupling two or more electronic devices. The assemblies can have a signal carrying component, an insulative component, and a steerable stiffening component (hereinafter, “stiffener”). A portion of the stiffener is secured to the signal carrying component. An unsecured portion of the stiffener can have a first disposition adjacent the signal carrying component and a second disposition spaced away from the signal carrying component. The unsecured portion can be configured for user deployment away from the conductor portion of the signal carrying component in a manner that permits the interface component to be positioned independently of a majority of the signal carrying component. This can allow a user to couple the assembly with a corresponding receptacle even when the receptacle is in a constrained volume that is difficult to access.

The various components described below may not be illustrated accurately as far as their size is concerned. Rather, the included figures are intended as diagrammatic representations to illustrate to the reader various inventive principles that are described herein.

Exemplary Printer System

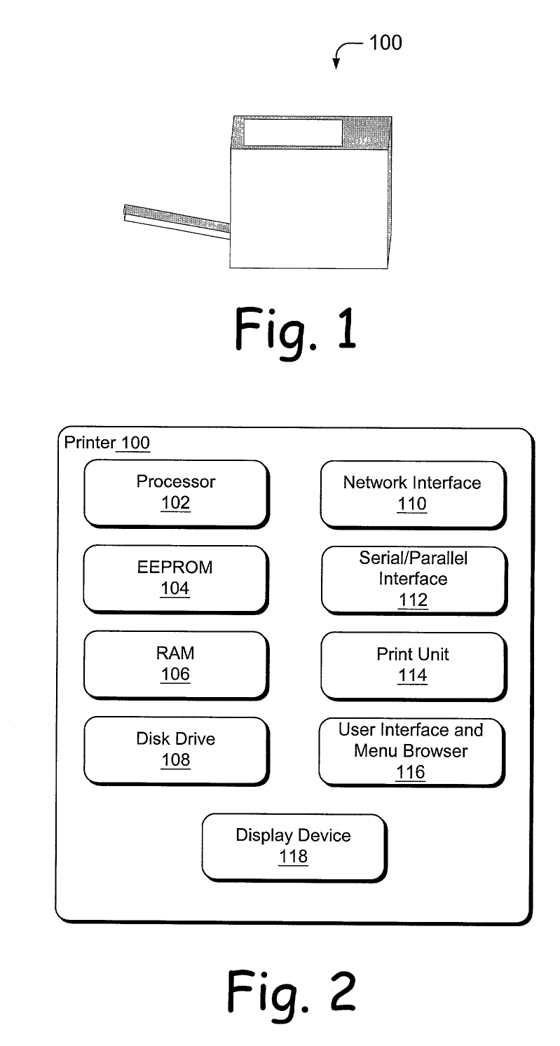

FIG. 1 depicts an exemplary printer 100. It will be appreciated and understood that the illustrated printer constitutes but one exemplary printing device and is not intended to be limiting in any way. Accordingly, other printing devices can be used in connection with the inventive techniques and systems described herein. These other printing devices can have components that are different from those described below.

FIG. 2 is a block diagram showing exemplary components of a printing device in the form of a printer 100 in accordance with one embodiment. Printer 100 includes a processor 102, an electrically erasable programmable read-only memory (EEPROM) 104, and a random access memory (RAM) 106. Processor 102 processes various instructions necessary to operate the printer 100 and communicate with other devices. EEPROM 104 and RAM 106 store various information such as configuration information, fonts, templates, data being printed, and menu structure information. Although not shown in FIG. 1, a particular printer may also contain a ROM (non-erasable) in place of or in addition to EEPROM 104. Furthermore, a printer may alternatively contain a flash memory device in place of or in addition to EEPROM 104.

Printer 100 can also include a disk drive 108, a network interface 110, and a serial/parallel interface 112. Disk drive 108 provides additional storage for data being printed or other information used by the printer 100. Although both RAM 106 and disk drive 108 are illustrated in FIG. 2, a particular printer can contain either RAM 106 or disk drive 108, depending on the storage needs of the printer. For example, an inexpensive printer may contain a small amount of RAM 106 and no disk drive 108, thereby reducing the manufacturing cost of the printer. Network interface 110 provides a connection between printer 100 and a data communication network. Network interface 110 allows devices coupled to a common data communication network to send print jobs, menu data, and other information to printer 100 via the network. Similarly, serial/parallel interface 112 provides a data communication path directly between printer 100 and another device, such as a workstation, server, or other computing device. Although the printer 100 shown in FIG. 2 has two interfaces (network interface 110 and serial/parallel interface 112), a particular printer may only contain one interface.

Printer 100 also includes a print unit 114 that includes mechanisms that are arranged to selectively apply ink (e.g., liquid ink, etc.) to a print media (e.g., paper, plastic, fabric, etc.) in accordance with print data within a print job. Those skilled in the art will recognize that there are many different types of print units available, and that for the purposes of the present embodiments print unit 114 can include any of these various types.

Printer 100 also contains a user interface/menu browser 116 and a display panel 118. User interface/menu browser 116 allows the user of the printer to navigate the printer's menu structure. User interface 116 may be a series of buttons, switches or other indicators that are manipulated by the user of the printer. The printer display or display device 118 is a graphical display that provides information regarding the status of the printer and the current options available through the menu structure.

Exemplary Host Computer

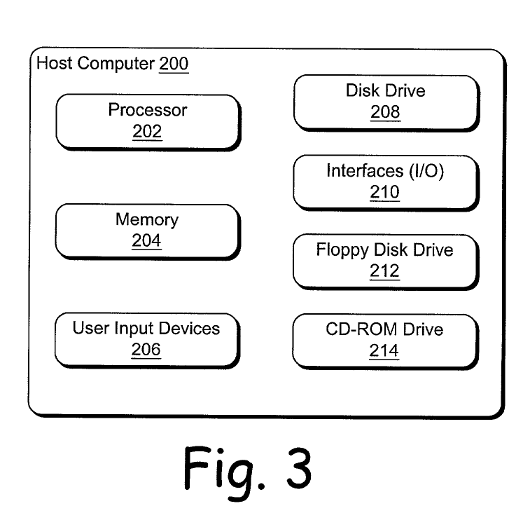

For purposes of understanding various structures associated with an exemplary host computer, consider FIG. 3.

FIG. 3 is a block diagram showing exemplary components of a host computer 200. Host computer 200 includes a processor 202, a memory 204 (such as ROM and RAM), user input devices 206, a disk drive 208, interfaces 210 for inputting and outputting data, a floppy disk drive 212, and a CD-ROM drive 214. Processor 202 performs various instructions to control the operation of computer 200. Memory 204, disk drive 208, and floppy disk drive 212, and CD-ROM drive 214 provide data storage mechanisms. User input devices 206 include a keyboard, mouse, pointing device, or other mechanism for inputting information to computer 200. Interfaces 210 provide a mechanism for computer 200 to communicate with other devices.

Exemplary Embodiment

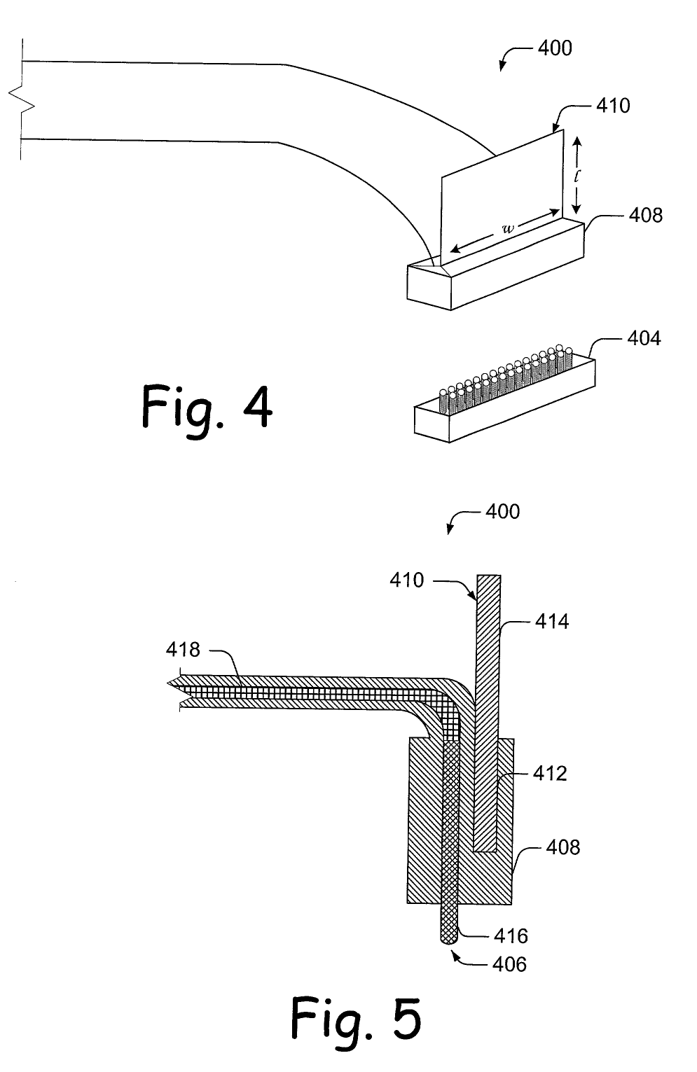

FIGS. 4 and 5 show exemplary embodiments that include an assembly 400. The assembly can be coupled with a corresponding connector or receptacle 404. The assembly has a signal carrying component 406 (FIG. 5), an insulating component 408, and a stiffener 410.

FIG. 5 shows the stiffener 410 having a secured portion 412 and a non-secured or unsecured portion 414. The non-secured portion 414 is shown manipulated away from the rest of the assembly and can be used to steer the assembly into the receptacle 404. In the illustrated embodiment, the secured portion is secured by actually molding that portion into the insulative component 408. By molding the secured portion 412 into the insulative component the stiffener is indirectly secured to the signal carrying component. Other types and configuration of insulative components will be discussed below.

As shown in FIG. 5, the signal carrying component can include an interface component 416 and a conductive component (“conductor”) 418. To aid in coupling with the receptacle, the interface component is often more rigid than the conductor. This rigidity can among other things allow the interface component to be inserted into a corresponding receptacle without deforming. The conductor is often more flexible to allow it to be conformed to various shapes. The interface component and the conductor are coupled to allow signals to pass from one to the other. In these exemplary embodiments, the interface component can comprise the terminal end or connector of the signal carrying component and the conductor can be the running length that comprises the majority of the length of the signal carrying component.

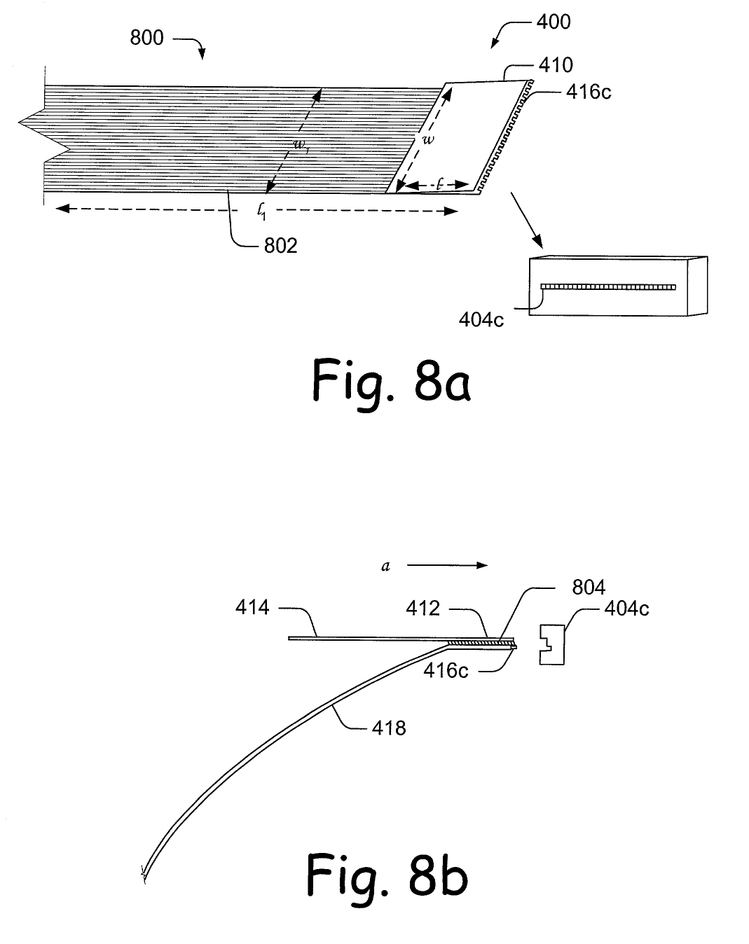

In other embodiments, the signal carrying component can be of homogenous construction for its entire length. In these exemplary embodiments, the construction of the signal carrying component is the same where it interfaces with a receptacle 404 as it is for the majority of its length. An example of such an embodiment is shown in FIG. 8 and will be discussed in more detail below. In still other exemplary embodiments, the signal carrying component can be configurable to be coupled with an existing signal carrier so that the assembly can aid in coupling the signal carrier with a corresponding receptacle.

In the exemplary embodiment shown in FIG. 5, the insulative component 408 is providing insulation to most of the signal carrying component 406. For example, FIG. 5 shows the insulating component 408 covering essentially the entire conductor 418 and a majority of the interface component 416. The stiffener's non-secured portion remains free of the insulative material. In other exemplary embodiments, the insulative component on the interface 416 can be different from that on the conductor 418. Still other embodiments can forego the insulative component altogether.

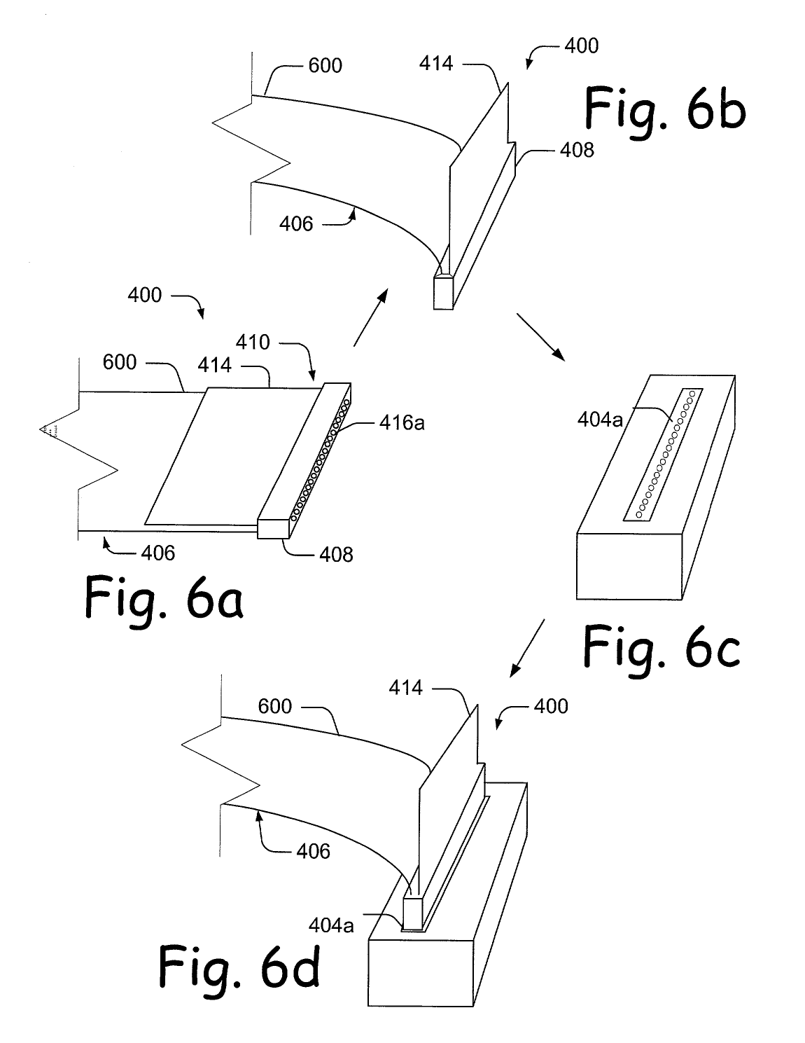

FIGS. 6a-6d illustrate how the assembly 400 can be steered or manipulated into the receptacle 404a by use of the stiffener 410. In this exemplary embodiment, the signal carrying component 406 comprises a flat flexible cable 600. FIG. 6a shows the stiffener's non-secured portion 414 in a first disposition adjacent the flat flexible cable 600. The secured portion of the stiffener is molded into the insulative component 408 and thus cannot be seen in the Figs. FIG. 6b shows the stiffener's non-secured portion deployed away from the flat cable 600 into a second disposition. Manipulation of the non-secured portion in this second disposition can allow the multiple interface components 416a to be positioned independently of the majority of the flat flexible cable (as in FIG. 6b) and into a receptacle 404a (FIG. 6d).

The stiffener can be less flexible than the flat flexible cable 600 and thus can aid in insertion into the receptacle 404a. In embodiments such as FIGS. 6a-6d where the signal carrying component comprises a flat flexible cable, the stiffener can also provide stiffness that can keep multiple interface components 416a generally linear so that the overall shape better matches the shape of the receptacle and is more easily inserted.

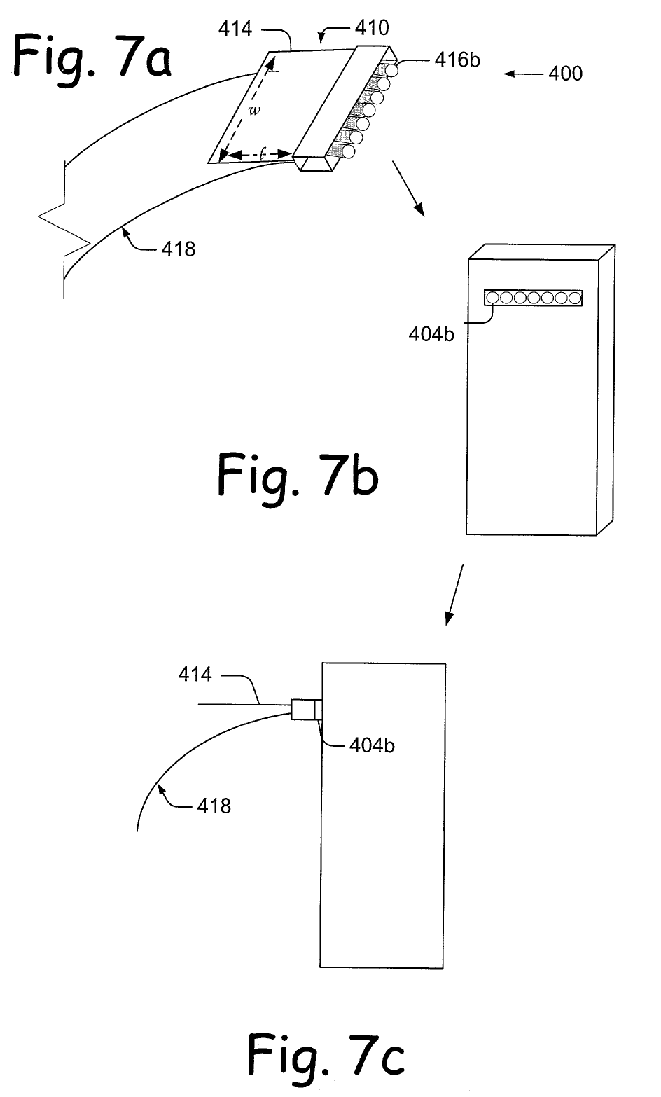

FIGS. 7a-7c show an exemplary embodiment where the unsecured portion 414 of the stiffener 410 has already been manipulated to a second disposition. From this orientation the interfaces 416b can be inserted into the receptacle 404b (FIG. 7b) regardless of the orientation of a majority of the conductor 418. As can be seen from FIG. 7c, the stiffener's unsecured portion 414 can be manipulated by a user for insertion of the interfaces into the receptacle while allowing the majority of the conductor to fall away.

FIGS. 8a and 8b show an embodiment where the signal carrying component comprises a flexible printed circuit 800. This type of circuit is commonly used for connecting various components within an electronic device, and can be comprised of multiple conductive traces 802. Flexible printed circuit 800 can have a width (w₁) and a length (l₁) as shown in FIG. 8a, and is quite flexible along both the width and the length. While this can be useful for allowing the cable to be conformed to the available space between various components, it can be problematic upon trying to insert the cable into a corresponding receptacle 404c. That is, the cable is not stiff enough to transfer sufficient force in a direction of insertion (a) (shown FIG. 8b) into the receptacle to couple the signal carrying component with the receptacle. Additionally, flexibility along the width can cause the cable to become curved or non-linear. As can be seen from the diagram, receptacle 404c is generally linear and any deviation along the width of the cable at the area of insertion can prevent insertion into the receptacle.

The addition of the partially secured stiffener 410 can eliminate these problems. For example, the stiffener can provide stiffness both in the direction of insertion, and along the width of the cable. In this embodiment, the stiffener is adhered or otherwise secured for a portion of its length as can be more clearly seen in FIG. 8b, which shows secured portion 412 and a non-secured portion 414. Any suitable adhesive 804 can be used and will be discussed in more detail below.

The partially secured stiffener can be manipulated from a first disposition as shown in FIG. 8a to a second disposition as shown in FIG. 8b. The stiffener provides beneficial stiffness in both of these dispositions, and can be more steerable or manipulatable for inserting the cable into the receptacle from the second disposition.

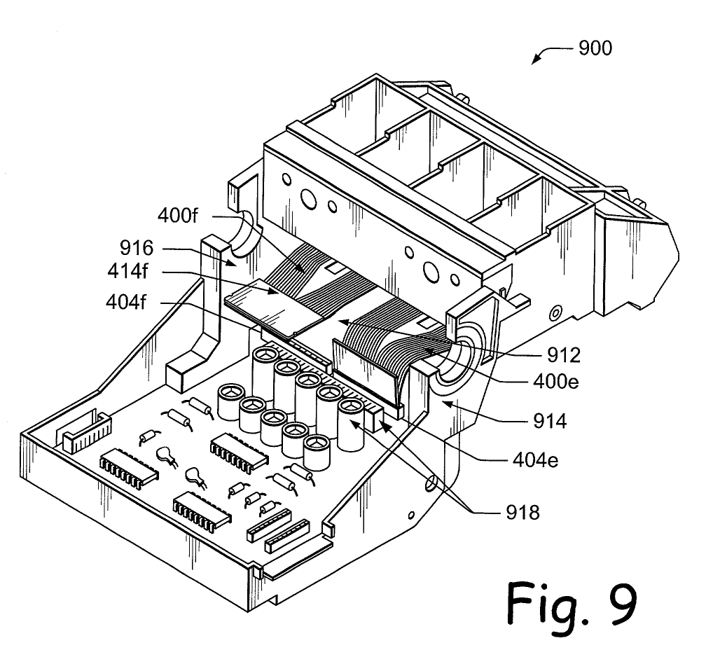

The embodiments that have been illustrated up to this point have for the sake of clarity been in very isolated environments. However, many receptacles found in and around exemplary electronic devices are in crowded environments that limit the space available for, and access to, the receptacle. A more representative environment can be seen in FIG. 9.

FIG. 9 is an exemplary embodiment comprising a portion of a print unit of a printer. The illustration shows a portion of the print unit comprising a print carriage 900. Further, the print carriage has two assemblies 400e and 400f. In this exemplary embodiment, the two assemblies are configured to couple with two receptacles 404e and 404f.

As can be seen from the FIG. 9, the volume surrounding the two receptacles 404e and 404f is constrained. For example, underneath and behind the receptacles are portions of the housing 912. Additionally, portions of the housing 914 and 916 are very near the sides of the receptacles. Further, it can be seen that various components 918 are protruding upwardly in front of the receptacles. Focusing now on receptacle 404e, it can be seen that the assembly 400e is inserted into the receptacle.

In contrast to assembly 400e, the assembly 400f is shown generally above, but not coupled with, receptacle 404f. Previously, it would be very difficult if not impossible to insert a traditional cable into the connector or receptacle due to the space constraints that limit the ability to insert one's hands or tools into the volume necessary for insertion. With the described embodiments, the manipulatable stiffener can be used to orient the assembly into alignment with the receptacle and allow sufficient downward force to be applied to insert the assembly into the receptacle to couple the signal carrying component with the receptacle. In this example, manipulation of the stiffener's non-secured portion 414f can allow sufficient steering and force to insert the assembly into the receptacle 404f.

As can be seen from FIG. 9, the non-secured portion of the stiffener can be graspable and manipulatable either by human or mechanical means. Manipulation of the stiffener can orient the assembly into the receptacle. In this exemplary embodiment, manipulation of the stiffener allows the assembly to be inserted into the receptacle without the installer's hands or equipment entering the confined volume.

FIG. 9 shows two assemblies, each having a single stiffener. However, other satisfactory embodiments can use a single signal carrying component such as a flexible printed circuit that is divided into multiple portions where each of the portions has a stiffener and is configured to be inserted into a corresponding receptacle. This can be advantageous where space constraints preclude a single large stiffener, or where it is economically advantageous to have several smaller receptacles instead of a single large one. For example, the embodiments shown in FIG. 9 could alternatively comprise a single embodiment where a flexible printed circuit has a terminal end that is divided into two or more portions each having their own stiffener. Each of the portions can be configured to be inserted into its own individual receptacle through manipulating its own stiffener. These are but a few of the possible embodiments. One of skill in the art will recognize others.

FIG. 9 shows an exemplary embodiment coupling components of a print carriage. Other satisfactory embodiments can be used to couple other components within a device. For example, an exemplary embodiment can be used to couple the print unit 114 to the processor 102, or the processor to the display device 118. Other embodiments can be used to connect various devices. For example, some embodiments can connect the printer 100 to the computer 200. This can be accomplished with an assembly that has a partially secured stiffener at each of two opposing ends and can couple the devices through coupling the signal carrying component to serial/parallel interface 112 and interface 210. Other possible embodiments will be recognized by those of skill in the art.

The assembly can be constructed from a variety of materials. The signal carrying component can comprise any suitable material. For example, in some embodiments, the signal carrying component can comprise a conductive material such as various metals, including but not limited to copper, aluminum, and various alloys. For example, metal circuits or more specifically conductive traces can be used in various embodiments. In other embodiments, the signal carrying component can comprise fiber optics to carry signals of the electromagnetic spectrum. Regardless of the type of signal to be carried, the signal carrying component can be comprised of multiple coupled portions or can be of homogeneous construction.

The stiffener can comprise any suitable material such as polyester, and/or multiple types of plastics, among others. It can be secured to the signal carrying component directly so that there is physical contact between the two components. The stiffener can also be secured indirectly where no physical contact occurs but manipulation of the stiffener caused manipulation of at a portion of the signal carrying component. In the described embodiments, securing the stiffener to the signal carrying component can include any satisfactory means of securing including, but not limited to, coupling, connecting, fastening, and adhering.

The insulative component can comprise any suitable material such as plastics, polyester, and other suitable polymers, among others. The insulative component, or portions thereof can be molded around other components of the assembly, such as is shown in FIG. 5. The molded insulative component can secure a portion of the stiffener to the assembly and leave a portion unsecured.

The insulative component can also be applied in layers and laminated. The insulative layers can provide adhesion themselves when exposed to certain conditions or adhesives can be used to bond the various components together. For example, in one exemplary embodiment, a flexible printed circuit that includes the partially secured stiffener is constructed through a lamination process by first applying a layer of insulation that is followed by a layer of adhesive. Conductive traces are placed over the adhesive and a second layer of adhesive and another layer on insulation over that. This is followed by a third layer of adhesive, and the stiffener of which only a portion is secured.

The adhesives can be exposed to conditions to cause them to bond to adjacent layers. Satisfactory adhesives can include various types such as pressure, or heat sensitive among others. One satisfactory adhesive is Nitto Denko 5000 NS. The cable and the stiffener can be cut to a desired width. The stiffener can be narrower, wider, or generally the same width as the cable. This is but one suitable configuration. The skilled artisan will recognize other satisfactory configurations.

First Exemplary Method

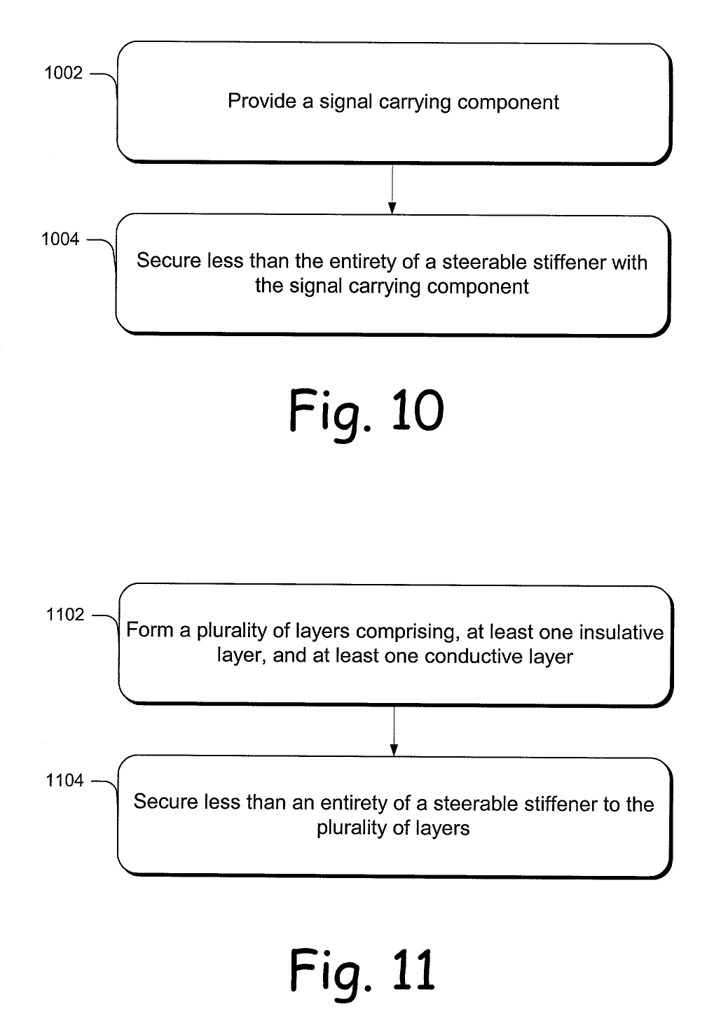

FIG. 10 is a flow diagram that describes steps in a method in accordance with one embodiment. Step 1002 provides at least one signal carrying component. As described above, the signal carrying component(s) can comprise various conductive metals as well as fiber optics to name just a few.

Step 1004 couples less than the entirety of a steerable stiffener with the signal carrying component(s). This can allow a non-secured portion of the steerable stiffener to be manipulated by a user from a first disposition adjacent to the signal carrying component(s) to a second non-adjacent disposition so that the signal carrying component(s) can be positioned by the user.

Second Exemplary Method

FIG. 11 is a flow diagram that describes steps in a method in accordance with one embodiment. Step 1102 forms a plurality of layers comprising, at least one insulative layer, and at least one conductive layer. Some exemplary embodiments have multiple insulative layers positioned around the conductive layer. Further, in some embodiments, these layers can be secured or otherwise bonded to each other prior to step 1104. Alternatively, adhering the layers can occur concurrently with coupling the stiffener to the layers.

Step 1104 couples less than an entirety of a steerable stiffener to the plurality of layers. A non-coupled portion of the steerable stiffener can then be used to steer the plurality of layers. The stiffener can be coupled in many ways. Some of the ways have been described above. Further, if an adhesive is used to couple the portion of the stiffener to the layers, then the same type of adhesive used to bond the layers together can be used and all of the adhesive layers exposed to conditions to cause them to bond to adjacent layers.

### CONCLUSION

The described embodiments can provide methods and systems for a coupling assembly. The assembly can have a signal carrying component, an insulative component, and a partially secured steerable stiffener. The stiffener's unsecured portion can have a first disposition closely adjacent the signal carrying component and a second disposition spaced away from the signal carrying component. The unsecured portion can be configured for user deployment away from the signal carrying component in a manner that permits the interface component to be positioned independently of a majority of the signal carrying component. This can allow a user to couple the assembly with a corresponding receptacle even when the receptacle is in a constrained volume.

Although the invention has been described in language specific to structural features and/or methodological steps, it is understood that the invention defined in the appended claims is not necessarily limited to the specific features or steps described. Rather, the specific features and steps are disclosed as preferred forms of implementing the claimed invention.

1. A coupling assembly, comprising:
at least one signal carrying component capable of being coupled with a corresponding receptacle; and,
at least one steerable component, at least a portion of which is secured with the signal carrying component, wherein a non-secured portion of the steerable component can be manipulated by a user from a first disposition generally adjacent a portion of the signal carrying component to a second non-adjacent disposition for steering the assembly into the receptacle.

2. The coupling assembly of claim 1, wherein the at least one signal carrying component comprises at least one electrical conductor.

3. The coupling assembly of claim 2, wherein the at least one electrical conductor comprises a cable.

4. The coupling assembly of claim 2, wherein the at least one electrical conductor comprises one or more conductive traces.

5. The coupling assembly of claim 2, wherein the at least one electrical conductor comprises a flexible printed circuit.

6. The coupling assembly of claim 1, wherein the at least one steerable component comprises polyester.

7. The coupling assembly of claim 1, wherein the at least one steerable component comprises plastic.

8. The coupling assembly of claim 1, wherein the at least one signal carrying component comprises multiple signal carrying components configured to be coupled with multiple corresponding receptacles.

9. The coupling assembly of claim 1, wherein the at least one steerable component is flat.

10. The coupling assembly of claim 9, wherein the at least one steerable component has a width and is coupled with the signal carrying component along a majority of the width.

11. The coupling assembly of claim 10, wherein the at least one signal carrying component has a width, and wherein the width of the signal carrying component is equal to the width of the steerable component.

12. The coupling assembly of claim 11, wherein the width of the steerable component has a rigidity and the width of the signal carrying component has a rigidity, and wherein the rigidity of the steerable component is greater than the rigidity of the signal carrying component.

13. The coupling assembly of claim 1, wherein the steerable component has a length and a rigidity associated with the length and the signal carrying component has a length and a rigidity associated with the length and wherein the rigidity of the length of the steerable component exceeds the rigidity of the length of the signal carrying component.

14. A coupling assembly, comprising:
a signal carrying component comprising at least one conductor and an interface component, wherein the at least one conductor is capable of carrying a signal for provision to an electronic device and is coupled with the interface component, the interface component being configured for receipt in an electronic device receptacle; and,
a steerable component having a secured portion on the signal carrying component and a non-secured portion, the non-secured portion having a first disposition adjacent the signal carrying component and a second disposition spaced away from the signal carrying component, the non-secured portion being configured for user deployment away from the signal carrying component in a manner that permits the interface component to be positioned independently of a position of at least a majority of the at least one conductor.

15. The coupling assembly of claim 14, wherein the signal carrying component comprises a flat cable.

16. The coupling assembly of claim 14, wherein the signal carrying component comprises a flexible printed circuit.

17. The coupling assembly of claim 14, wherein the steerable component provides stiffness that allows force to be applied to insert the interface component into the receptacle.

18. The coupling assembly of claim 14, wherein the non-secured portion is configured to be manipulatable by a user for positioning the interface component into the receptacle.

19. The coupling assembly of claim 18, wherein the receptacle is located in a constrained volume.

20. The coupling assembly of claim 19, wherein the non-secured portion extends beyond the constrained volume.

21. The coupling assembly of claim 14, wherein the at least one conductor comprises at least one trace.

22. The coupling assembly of claim 14, wherein the steerable component is mounted to the interface component.

23. The coupling assembly of claim 14, wherein the steerable component comprises polyester.

24. The coupling assembly of claim 14, wherein the steerable component comprises plastic.

25. A method of forming a coupling assembly, comprising:
forming a plurality of layers comprising at least one insulative layer and at least one conductive layer; and,
securing less than an entirety of a steerable stiffener to the plurality of layers, wherein a non-secured portion of the steerable stiffener allows a portion of the plurality of layers to be steered.

26. The method of claim 25, wherein forming a plurality of layers comprises adhering the at least one insulative layer to the at least one conductive layer.

27. The method of claim 25, wherein forming a plurality of layers comprises positioning a conductive layer between a first insulative layer and a second insulative layer.

28. The method of claim 25, wherein said forming a plurality of layers comprises forming a flexible printed circuit having a plurality of layers.

29. A method of forming a coupling assembly, comprising:
providing at least one signal carrying component; and,
securing less than the entirety of a steerable stiffener with the at least one signal carrying component in a manner that allows a non-secured portion of the steerable stiffener to be manipulated by a user from a first disposition adjacent to the signal carrying component to a second non-adjacent disposition so that the at least one signal carrying component can be positioned by the user.

30. The method of claim 29, wherein said securing comprises securing the steerable stiffener to an intermediate insulative component that effectively secures the steerable stiffener to the signal carrying component.

31. The method of claim 29, wherein said providing at least one signal carrying component comprises providing multiple electrically conductive traces.

32. The method of claim 29, wherein said providing at least one signal carrying component comprises providing a flexible printed circuit.

33. The method of claim 29, wherein said providing at least one signal carrying component comprises providing a flat flexible cable.

34. A coupling assembly, comprising;
a stiffener capable of transferring force in a given direction;
less than the entirety of the stiffener configured to be secured to a signal carrying component; and
a non-secured portion of the stiffener configured to be manipulated by a user from first disposition generally adjacent a portion of the signal carrying component to a second non-adjacent disposition for steering a portion of the signal carrying component into a corresponding receptacle.

35. The coupling assembly of claim 34, wherein the non-secured portion is configured to manipulate the signal carrying component into the corresponding receptacle where the receptacle is in a confined space.

36. The coupling assembly of claim 35, wherein the non-secured portion is configured to manipulate the signal carrying component into the receptacle with less than an entirety of the non-secure portion entering the confined space.
